(19) United States
(12) Patent Application Publication
(10) Pub. No.: US 2005/0117822 A1
(43) Pub. Date: Jun. 2, 2005

(54) Bearing for heat dissipating fan

(76) Inventors: Abin Chen, Taoyuan City (TW); Shih H. Chen, Taoyuan City (TW)

Correspondence Address: HDSL, 4331 STEVENS BATTLE LANE, FAIRFAX, VA, 22033, US

(21) Appl. No.: 10/724,771

(22) Filed: Dec. 2, 2003

(51) Int. Cl. F16C 32/06

(52) U.S. Cl. 384/100

(57) ABSTRACT

An improved bearing for a heat dissipation fan has an oil chamber for containing lubricant. The oil chamber has a sidewall extending between one open end and one closed end. The closed end is perforated with a through hole, and an edge of the sidewall at the open end is partially recessed to form at least one notch. An external surface of the sidewall is partially recessed along an elongate direction to form at least one oil slot aligned with the notch, the recessed external sidewall is further perforated with a through hole. An O-ring is disposed adjacent to the closed end of the oil chamber. The O-ring has an aperture aligned with the through hole of the closed end. An axial column is inserted into the oil chamber through the aperture of the O-ring and the through hole of the closed end. An external sleeve is used for receiving the oil chamber therein. The central axis column is operative to rotate within the oil chamber, such that the lubricant contained in the oil chamber is driven to flow upwardly through the notch into the oil slot. The axial column is so configured to prevent the lubricant from flowing external to the oil chamber via the through hole of the closed end.

### BACKGROUND OF THE INVENTION

The present invention relates to an improved bearing for a heat dissipation fan, and more particular, to an improved bearing which uses an external lid and a through hole of an oil tank to effective prevent the liquid lubricant to leak out of the fan. Further, the liquid lubricant is guided to reflow into the hydraulic bearing to suppress consumption of the liquid lubricant, so as to prolong the lifetime of the central axis and hydraulic bearing and reduce noise caused by friction.

The commonly seen heat dissipation fan structures are normally installed in electronic or electric device to dissipate heat generated by operation of the electronic or electric device. The electronic or electric device is protected from high temperature to obtain a longer lifetime. The electronic or electric device includes computer motherboard, VCR or copy machine.

FIG. 1 shows a conventional heat dissipation fan structure 1a. As shown, the fan structure 1a includes a blade base 10a and a body member 11a. The blade base 10 includes a hollow member and blades 100a extending from an external periphery of the hollow member. A magnet 101a is installed along an internal periphery of the hollow member. A positioning axis 102a protrudes from a top surface of the blade base 10a along a central axis thereof. The body member 11a further comprises a blade positioning seat 110a and a column 111a protruding along a central axis from a bottom of the body men 11a. The column 111a is hollow and has an elongate hole 112a and a supporting plane 113a protruding from an internal periphery to intersect the elongate hole 112a. The supporting plane 113a is capped with a bearing 12a which includes an axial hole 120a. An electric circuit board 114a and a coil 115a are further attached to the external sidewall of the protruding column 111a.

In the above structure, the positioning axis of the blade base 10a is inserted into the axial hole 120a of the bearing 12a. The positioning axis 102a further comprises two circular oil rings 103a and 104a at two end surfaces of the bearing 12a. The magnet 101a of the blade base 10a is located along the external periphery of the coil 115a. Therefore, when the electric circuit board 114a and the coil 115a are conducted with a power source, the blades 100a rotate by the rotation of the positioning axis 102a within the bearing. Meanwhile, a relative rotation between the positioning axis 102a and the bearing 12a will release lubricant from a sintered hole thereof to lubricate the bearing 12a and the positioning axis 102a.

However, the lubricating system in the above structure is not optimized for having the following drawbacks:
1. When the oil ring 103a rotates with rotation of the positioning axis 102a, the friction between the end surfaces of the bearing 12a causes the lubricant released from the sintered hole of the bearing 12a and sprayed centrifugally. The lubricant then flows from the gap 116a to cause extra consumption.
2. The oil contained in the bearing 12a becomes less and less. When the oil in the bearing 12a is totally consumed, friction between the positioning axis 102a and the bearing 12a is excessive to cause damage. Consequently, noise of the fan 1a is increased, and heat is generated to affect operation of computer and lifetime of the electronic or electric device.

### BRIEF SUMMARY OF THE INVENTION

The present invention provides an improved bearing for a heat dissipation fan, which uses blockage of a central column and a through hole of a oil tank to effectively prevent lubricant leakage. Further, the lubricant is guided to reflow into the hydraulic bearing to reduce consumption thereof.

The present invention further provides an improved bearing for a heat dissipation fan of which the lubricating and heat dissipating effects are enhanced, such that the heat dissipation efficient is enhanced, the lifetime of the bearing is prolonged, and the noise caused by friction is reduced.

The improved bearing provided by the present invention comprises a hydraulic bearing comprising an oil chamber for containing lubricant. The oil chamber includes a sidewall extending between one open end and one closed end, wherein the closed end is perforated with a through hole, and an edge of the sidewall at the open end is partially recessed to form at least one notch. An external surface of the sidewall is partially recessed along an elongate direction to form at least one oil slot aligned with the notch, the recessed external sidewall is further perforated with a through hole. An O-ring is disposed adjacent to the closed end of the oil chamber. The O-ring has an aperture aligned with the through hole of the closed end. An axial column is inserted into the oil chamber through the aperture of the O-ring and the through hole of the closed end. An external sleeve is used for receiving the oil chamber therein. The central axis column is operative to rotate within the oil chamber, such that the lubricant contained in the oil chamber is driven to flow upwardly through the notch into the oil slot. The axial column is so configured to prevent the lubricant from flowing external to the oil chamber via the through hole of the closed end. The external sleeve includes a sidewall extending between an open end and a closed end. The hydraulic bearing further comprises a pad disposed in the external sleeve on the closed end thereof before the oil chamber is received therein.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 shows a cross-sectional view of a conventional heat dissipation fan;

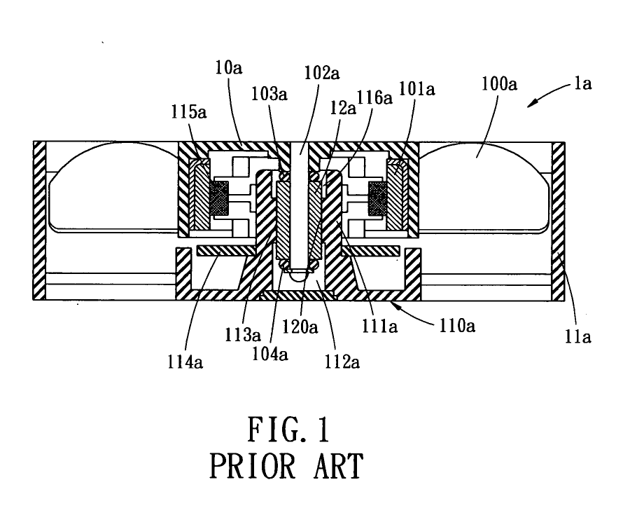

FIG. 2 shows a perspective view of a bearing provided by the present invention;

FIG. 3 shows an exploded view of the bearing;

FIG. 4 shows a cross-sectional view of the bearing; and

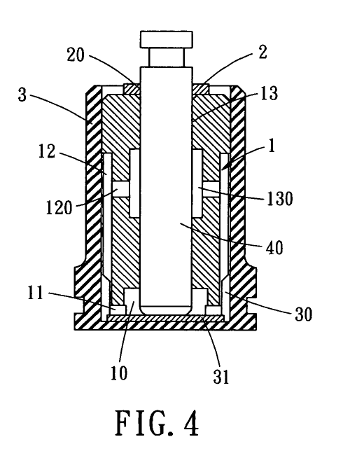

FIG. 5 shows the reflow of the lubricant.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

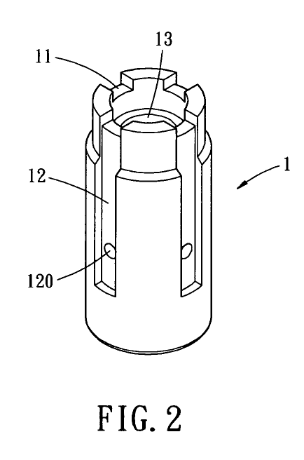

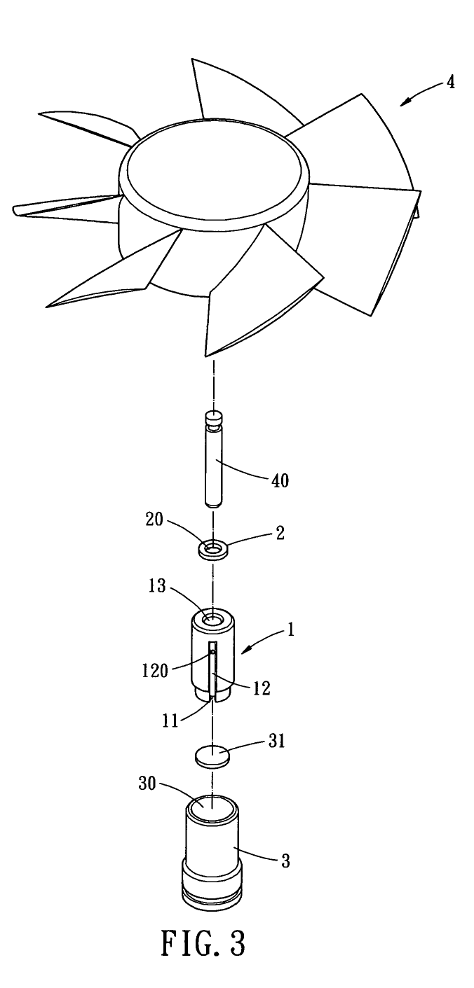

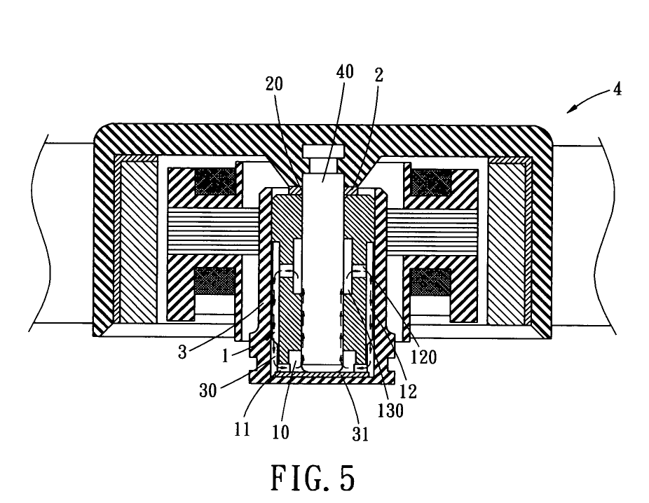

Referring to FIGS. 2-3, the present invention provides a hydraulic bearing 1 including an oil chamber 10 for containing liquid lubricant therein. Preferably, the oil chamber 10 includes a cylindrical sidewall with one end open and the other end closed. The edge of the sidewall of the oil chamber 10 at the open end is partially recessed to form notches 11 as shown in FIG. 2, and the external surface of the sidewall is partially recessed to form oil slots 12 aligned with the notches 11. In the embodiment as shown in FIG. 2, the oil slots 12 are not formed through the elongate length of the sidewall. That is, the oil slots 12 extend from the open end, but do not reach the closed end of the oil chamber 10. However, it will be appreciated that the length and extension of the oil slots 12 can be modified or altered without exceeding the scope and spirit of the present invention. Each of the recessed portions of the external sidewall is further perforated with a hole 120, such that the oil chamber 10 is in communication with the oil slots 12 through the holes 120. As shown in FIG. 5, the closed end of the oil chamber 10 is perforated with a hole 130 at a center thereof. The hydraulic bearing 1 further comprises an O-ring 2 fabricated from plastic material. The O-ring 2 is disposed adjacent to the open end of the oil chamber 10 with an aperture 20 thereof aligned with the hole 130. An axial column 40 is inserted into the oil chamber 10 through the aperture 20 and the hole 130, and a hollow column 3 with a chamber 30 is used to receive the oil chamber 10 therein. Similar to the oil chamber 10, the hollow column 3 is open at one end and close at the other end. A pad 31 is disposed on the closed end of the chamber 30 before the oil chamber 10 is received therein.

In application, when the axial column 40 inserted into the oil chamber 10 is rotating, the lubricant contained in the oil chamber 10 flows upward towards the open end of the oil chamber 10. The lubricant then overflows through the notches 11 at the open end towards the oil slots 12. The holes 120 then guide the lubricant to flow back into the oil chamber 10. During the circulation of the lubricant, as the axial column 40 is inserted into the oil chamber 1o through the hole 130, the lubricant is prevented from flowing out of the oil chamber 10 from the hole 130. Therefore, the lubricant can be circulated within the hydraulic bearing without causing great consumption thereof.

Accordingly, the hydraulic bearing provided by present invention has at least the following advantages.
1. The insertion of the axial column into the oil chamber provide blockage of the lubricant contained within oil chamber, such that the lubricant will not flow out of the bearing by rotation of the axial column.
2. The oil slot and the hole communicating the oil slot and the oil chamber allows the lubricant circulating and recycled within the hydraulic bearing, such that the lubricating effect will not be deteriorated by leakage of lubricant. As a result, the heat dissipation efficient of the fan is improved, the lifetime of the fan is prolonged, and the noise caused by friction is reduced.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. An improved bearing for a heat dissipation fan, comprising:
a hydraulic bearing, comprising:
an oil chamber for containing lubricant, the oil chamber includes a sidewall extending between one open end and one closed end, wherein the closed end is perforated with a through hole, an edge of the sidewall at the open end is partially recessed to form at least one notch, and an external surface of the sidewall is partially recessed along an elongate direction to form at least one oil slot aligned with the notch, the recessed external sidewall is further perforated with a through hole;
an O-ring disposed adjacent to the closed end of the oil chamber, the O-ring has an aperture aligned with the through hole of the closed end;
an axial column, inserted into the oil chamber through the aperture of the O-ring and the through hole of the closed end; and
an external sleeve for receiving the oil chamber therein.

2. The bearing of claim 1, wherein the central axis column is operative to rotate within the oil chamber, such that the lubricant contained in the oil chamber is driven to flow upwardly through the notch into the oil slot.

3. The bearing of claim 2, wherein the axial column is so configured to prevent the lubricant from flowing external to the oil chamber via the through hole of the closed end.

4. The bearing of claim 1, wherein the external sleeve includes a sidewall extending between an open end and a closed end.

5. The bearing of claim 1, wherein the hydraulic bearing further comprises a pad disposed in the external sleeve on the closed end thereof before the oil chamber is received therein.
